(19) United States
(12) Patent Application Publication
(10) Pub. No.: US 2009/0314400 A1
(43) Pub. Date: Dec. 24, 2009

(54) Protective Cover With Power Supply Unit For Portable Electronic Device

(76) Inventor: Keng-Yuan Liu, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/145,410

(22) Filed: Jun. 24, 2008

(51) Int. Cl. B65D 85/00; H02J 7/00

(52) U.S. Cl. 150/165; 206/320; 320/114

(57) ABSTRACT

A protective cover with power supply unit for portable electronic device includes a covering unit having a back and a front cover; a power supply unit including a charging battery embedded in the back cover and a connector located on an outer side of the back cover at a predetermined position to electrically connect to the charging battery; and a fixing unit including a supporting plate fixed to an inner side of the back cover, a stop block formed on the supporting plate at a lower end thereof, a holding-down element located on the supporting plate at an upper end thereof opposite to the stop block, and a mating connector provided on the stop block and electrically connected to the charging battery. A portable electronic device may be connected to the fixing unit to obtain power from the power supply unit and be protected by the covering unit against damage.

### FIELD OF THE INVENTION

The present invention relates to a protective cover for portable electronic device, and more particularly to a protective cover with power supply unit for portable electronic device, so that a portable electronic device held in the protective cover is not only protected against damage, but also timely supplied with required working power.

### BACKGROUND OF THE INVENTION

To protect the display and outer case of a general portable electronic device, such as a cell phone, a personal digital assist (PDA), or a multimedia player against scratches, the portable electric device is usually held in a leather, plastic, or silicone protective cover.

Such a protective cover has only one function, that is, to protect the portable electronic device. And, when it is desired to replace the battery of the portable electronic device with a new one, the portable electronic device must be removed from the protective cover first. This is obviously inconvenient for a user to do so.

A biggest problem encountered by the portable electronic device is the power supply thereof. A user would usually carry about one or more spare batteries with him or her when the portable electronic device is prepared for use outdoors. These spare batteries are normally positioned in a knapsack, and are in direct contact with other items in the knapsack. Therefore, the spare batteries not only occupy additional space in the knapsack, but also interference with other items in the knapsack to therefore become damaged.

It is therefore tried by the inventor to develop a protective cover with power supply unit for portable electronic device, so that the protective cover may be directly charged to supply working power needed by the portable electronic device held in the protective cover.

### SUMMARY OF THE INVENTION

A primary object of the present invention is to provide a protective cover with power supply unit for portable electronic device, so that a portable electronic device held in the protective cover is not only protected against damage, but also timely supplied with required working power.

To achieve the above and other objects, the protective cover with power supply unit for portable electronic device according to the present invention includes a covering unit having a back and a front cover connected together end to end; a power supply unit associated with the covering unit, and including a charging battery embedded in the back cover and a connector located on an outer side of the back cover at a predetermined position to electrically connect to the charging battery; and a fixing unit associated with the covering unit, and including a supporting plate fixed to an inner side of the back cover, a stop block formed on the supporting plate at a lower end thereof, a holding-down element located on the supporting plate at an upper end thereof opposite to the stop block, and a mating connector provided on the stop block and electrically connected to the charging battery.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded front perspective view of a protective cover with power supply unit for portable electronic device according to a preferred embodiment of the present invention;

FIG. 2 is an assembled view of FIG. 1;

FIG. 3 is a rear view of FIG. 2;

FIG. 4 shows the protective cover of the present invention may be charged via a cable;

FIG. 5 is an exploded perspective view showing the connection of a portable electronic device to the protective cover of the present invention; and

FIG. 6 is an assembled view of FIG. 5.

### DETAILED DESCRIPTION OF THE PREFERRED EMBODIMENTS

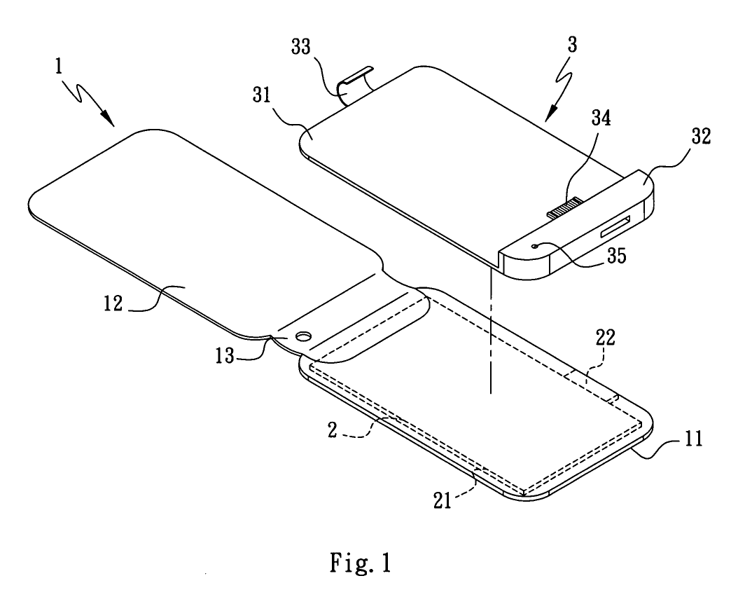

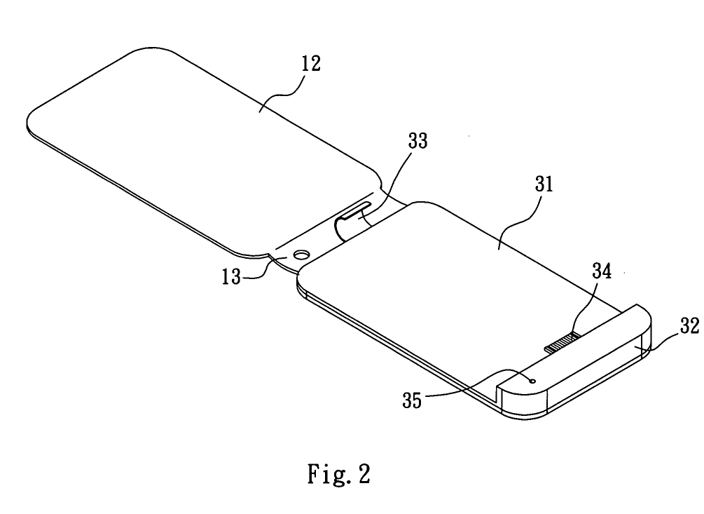

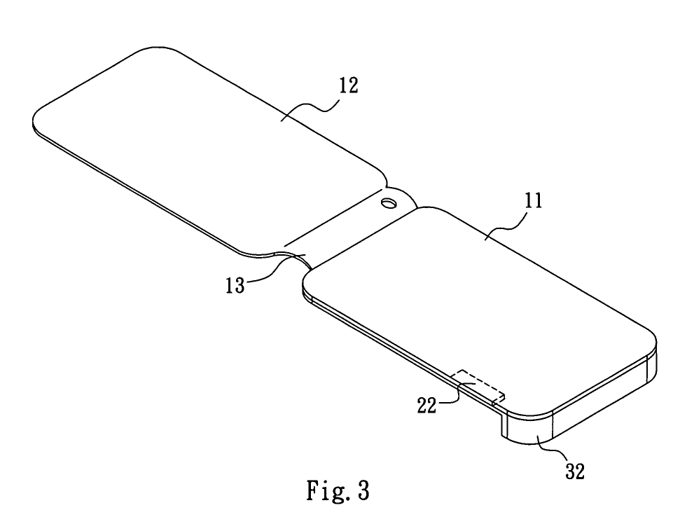

Please refer to FIGS. 1 and 2 that are exploded and assembled front perspective views, respectively, of a protective cover with power supply unit for portable electronic device according to a preferred embodiment of the present invention, and to FIG. 3 that is a rear view of FIG. 2. As shown, the protective cover of the present invention includes a covering unit 1, a power supply unit 2, and a fixing unit 3.

The covering unit 1 includes a back cover 11 and a front cover 12 connected end to end via an interconnecting section 13 located therebetween. In a preferred embodiment, the covering unit 1 is made of a leather material.

The power supply unit 2 is associated with the covering unit 1, and includes a charging battery 21 embedded in the back cover 11, and a connector 22 located at a predetermined position on an outer side of the back cover 11 to electrically connect to the charging battery 21.

The fixing unit 3 is associated with the covering unit 1, and includes a supporting plate 31 fixed to an inner side of the back cover 11, a stop block 32 formed on the supporting plate 31 at a lower end thereof, a holding-down element 33 formed on the supporting plate 31 at an upper end thereof opposite to the stop block 32, and a mating connector 34 provided on the stop block 32 and electrically connected to the charging battery 21. The stop block 32 is provided at a predetermined position with a power indicator 35 being electrically connected to the charging battery 21.

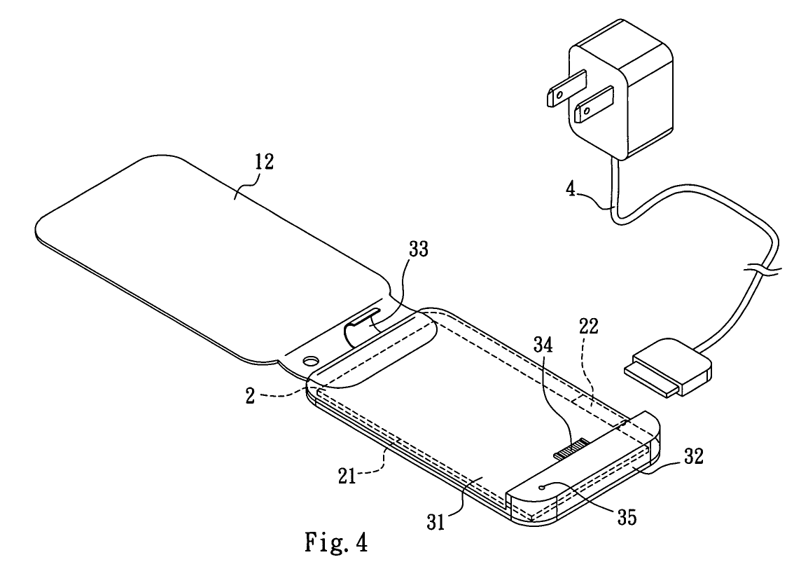

Please refer to FIG. 4. To charge the charging battery 21, a cable 4 is connected at an end to an external power supply (not shown) and at the other end to the connector 22 of the power supply unit 2, so that power is supplied from the external power supply to the charging battery 21 via the cable 4. When the charging battery 21 is fully charged, the cable 4 is unplugged from the connector 22, and the protective cover may be used outdoors. The power indicator 35 on the stop block 32 emits different color lights during and after the course of charging. For example, the power indicator 35 emits red light during charging and then turns to green light after the battery is fully charged.

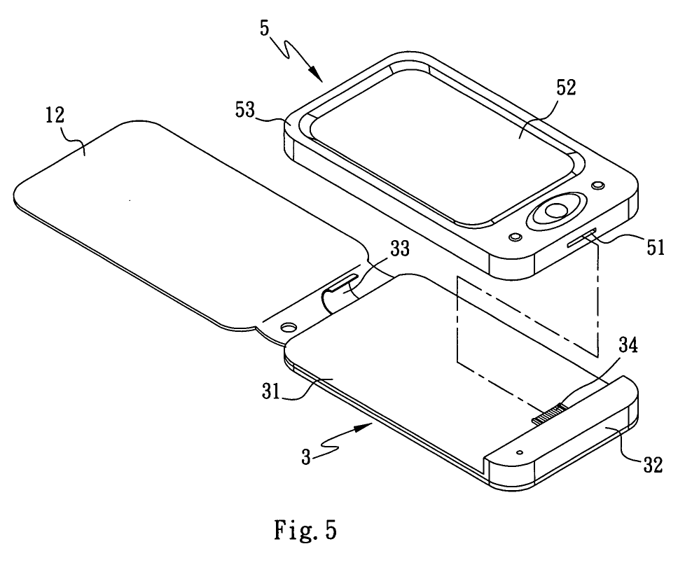

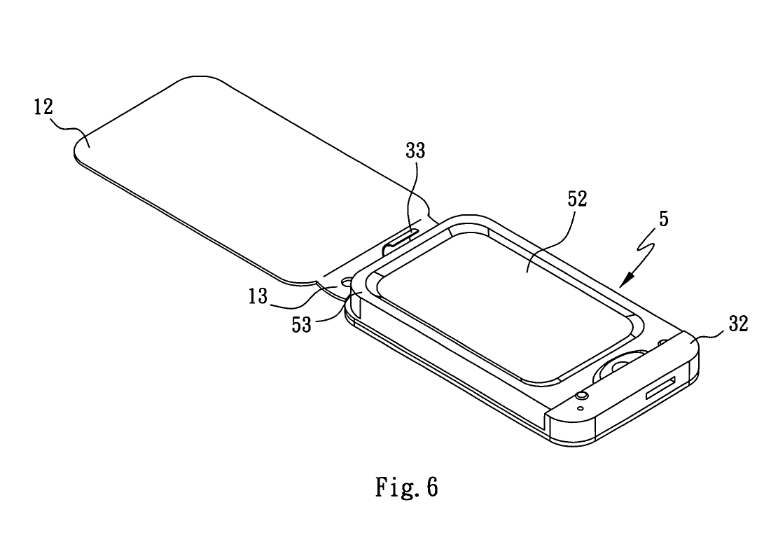

Please refer to FIGS. 5 and 6. When it is desired to use a portable electronic device 5 outdoors, such as a cell phone, a personal digital assistant (PDA), or a multimedia player, a user may hold the portable electronic device 5 in the protective cover of the present invention by engaging a socket 51 formed at a lower end of the portable electronic device 5 with the mating connector 34 on the stop block 32, and then moving the portable electronic device 5 toward the supporting plate 31, such that the holding-down element 33 cooperates with the stop block 32 to hold the portable electronic device 5 in place on the fixing unit 3. At this point, power is supplied from the charging battery 21 to the portable electronic device 5 via the mating connector 34, and the portable electronic device 5 is ready for use. And, when the portable electronic device 5 is not in use, the front cover 12 of the covering unit 1 may be turned about the interconnecting section 13 toward the portable electronic device 5 to cover the latter, so as to protect a display 52 and an outer case 53 of the portable electronic device 5 against damage.

Of course, it is also possible to charge the power supply unit 2 while the portable electronic device 5 is connected to the mating connector 34. In this manner, a user may use the portable electronic device 5 while the power supply unit 2 of the protective cover is being charged, making the present invention more practical for use.

With the above arrangements, a portable electronic device may be fixed to the fixing unit and covered by the covering unit, and may be timely supplied with working power via the power supply unit. Therefore, the protective cover with power supply unit for portable electronic device according to the present invention is novel, improved, and practical for use to effectively overcome the disadvantages in the conventional protective covers for portable electronic devices.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A protective cover with power supply unit for portable electronic device, comprising:
a covering unit including a back cover and a front cover connected together end to end;
a power supply unit being associated with the covering unit, and including a charging battery embedded in the back cover and a connector located on an outer side of the back cover at a predetermined position to electrically connect to the charging battery; and
a fixing unit being associated with the covering unit, and including a supporting plate fixed to an inner side of the back cover, a stop block formed on the supporting plate at a lower end thereof, a holding-down element located on the supporting plate at an upper end thereof opposite to the stop block, and a mating connector provided on the stop block and electrically connected to the charging battery.

2. The protective cover with power supply unit for portable electronic device as claimed in claim 1, wherein the covering unit is made of a leather material.

3. The protective cover with power supply unit for portable electronic device as claimed in claim 1, wherein the back cover and the front cover are connected with each other via an interconnecting section located therebetween.

4. The protective cover with power supply unit for portable electronic device as claimed in claim 1, wherein the stop block is provided at a predetermined position with a power indicator being electrically connected to the charging battery.
